(19) United States
(12) Patent Application Publication
(10) Pub. No.: US 2008/0037407 A1
(43) Pub. Date: Feb. 14, 2008

(54) Method for Manufacturing Perpendicular Magnetic Recording Medium, Perpendicular Magnetic Recording Medium, and Magnetic Recording/Reproducing Apparatus

(75) Inventors: Migaku Takahashi, Miyagi-ken (JP); Masahiro Oka, Chiba-ken (JP); Akira Kikitsu, Yokohama-shi (JP)

Correspondence Address: SUGHRUE MION, PLLC, 2100 PENNSYLVANIA AVENUE, N.W., SUITE 800, WASHINGTON, DC, 20037, US

(73) Assignee: Kabushiki Kaisha Toshiba, Tokyo (JP)

(21) Appl. No.: 11/662,492

(22) PCT Filed: Sep. 15, 2005
(86) PCT No.: PCT/JP05/17426

§ 371 Date: Mar. 15, 2007

Related U.S. Application Data
(60) Provisional application No. 60/614,462, filed on Oct. 1, 2004.

(30) Foreign Application Priority Data
Sep. 17, 2004 (JP) 2004-272071

(51) Int. Cl. G11B 5/84; G11B 5/64; G11B 5/65; G11B 5/82

(52) U.S. Cl. 369/288; 369/272.1; 428/826; 428/833

(57) ABSTRACT

One object of the present invention is to provide a perpendicular magnetic recording medium having a high coercive force by annealing, and in order to achieve the object, the present invention provides a method for manufacturing a perpendicular magnetic recording medium comprising a magnetic recording layer deposited on a non-magnetic substrate, in which at least a magnetic layer containing Co and a diffusive layer are stacked each other, and the stacked layers are annealed to produce a magnetic recording layer.

### CROSS-REFERENCE TO RELATED APPLICATIONS

This application claims the benefit pursuant to 35 U.S.C. §119 (e) of U.S. Provisional Application No. 60/614,462 filed on Oct. 1, 2004, and priority is claimed on Japanese Patent Application No. 2004-272071, filed Sep. 17, 2004, and U.S. Provisional Applications 60/614,462 filed on Oct. 1, 2004, the contents of which are incorporated herein by reference.

### TECHNICAL FIELD

The present invention relates to a method for manufacturing a perpendicular magnetic recording medium, a perpendicular magnetic recording medium, and a magnetic recording/reproducing apparatus. In particular, the present invention relates to a high density recording medium having high coercive force and a magnetic recording/reproducing apparatus comprising the same.

### BACKGROUND ART

Recently, the scope of application of magnetic recording apparatuses such as a magnetic disc apparatus, a FLOPPY® disc device, a magnetic tape device, and the like has advanced remarkably, and the importance thereof has increased. With these movements, effects have been made to increase the recording density of magnetic recording media used in these devices. For example, in accordance with density growth of magnetic recording media, since MR heads, GMR heads, and TMR heads are now used as recording/reproducing heads and PRML (Partial Response Maximum Likelifood) technology has been introduced as digital signal error modification technology, the recording density has increased remarkably. Recently, recording density has been increasing at a rate of 60% per year.

As described above, it is desired the recording density of magnetic recording media be further increased. In order to achieve this, enhancement of coercive force and signal to noise ratio (S/N ratio) of a magnetic recording layer, and high resolution is required. In a longitudinal magnetic recording conventionally used, when the recording density increases, the de-magnetizing effect, in which adjacent magnetic domains decrease the magnetization thereof of each other, also increases. Therefore, in order to avoid this, it is necessary to make the magnetic recording layer thinner for increasing magnetic shape anisotropy.

However, when the thickness of the magnetic recording layer decreases, energy barrier for maintaining a magnetic domain reaches the thermal fluctuation energy at room temperature. Due to this, it is impossible to ignore the decay of the magnetization (thermal fluctuation phenomena). It is said that this phenomena limits the recording density.

As technology for improving the recording density in a longitudinal magnetic recording, AFC (Anti Ferro Coupling) media have recently been suggested in order to solve the problem of thermal decay of magnetization, which is a problem in a longitudinal magnetic recording.

Perpendicular magnetic recording technology has received much attention as a useful alternative technology for achieving a higher recording density. In a conventional longitudinal magnetic recording, a medium is magnetized in an in-plane direction. In contrast, a perpendicular magnetic recording is characterized by magnetizing a medium in a perpendicular direction relative to the surface of a medium. This feature suppress the de-magnetizing effect, which prevents recording density growth, in a longitudinal magnetic recording, and is thought to be more suitable technology for high density recording. In addition, since the thickness of a magnetic layer can be maintained for high density recording, the thermal decay of magnetization, which is a problem in a longitudinal magnetic recording, is relatively small.

As a method for manufacturing a magnetic layer of a high density magnetic recording medium, a method, where an oxide layer containing zirconium or hafnium and a magnetic layer are stacked as a mixing layer and then the mixing layer is annealed, is disclosed in Japanese Unexamined Patent Application, First Publication No. 2000-79066. However, this manufacturing method is applied to a magnetic film having a granular structure using oxides. As a method for manufacturing the perpendicular magnetic recording media, sputtering a CoCr alloy with heating the substrate is proposed (for example, doctoral thesis by Kazuhiro Ouchi, Tohoku University, 1984).

As explained above, though a perpendicular magnetic recording medium has excellent properties, enhancement of the coercive force is still very important, similar to a the case of a longitudinal magnetic recording medium. Further enhancement of the coercive force is desired in a perpendicular magnetic recording medium.

An object of the present invention is to provide a perpendicular magnetic recording medium having a higher coercive force by annealing process.

### DISCLOSURE OF INVENTION

In order to achieve the object described above, the present invention provides the following methods for manufacturing a perpendicular magnetic recording medium, a perpendicular magnetic recording medium, and a magnetic recording/reproducing apparatus.

(1) A method for manufacturing a perpendicular magnetic recording medium comprising a magnetic recording layer on a non-magnetic substrate, in which at least a magnetic layer containing Co and a diffusive layer are stacked each other, and the stacked layers are annealed to produce a magnetic recording layer.

(2) A method for manufacturing a perpendicular magnetic recording medium according to (1), wherein the diffusive layer is a pure metal film or an alloy film.

(3) A method for manufacturing a perpendicular magnetic recording medium according to (1) or (2), wherein the diffusive layer is laminated on and/or under the magnetic layer.

(4) A method for manufacturing a perpendicular magnetic recording medium according to any one of (1) to (3), wherein the diffusive layer contains elements having an atomic radius of 1.60 angstroms or less, a melting point of 2,500° C. or less, and an enthalpy of formation of an alloy with Co being −40 kJ/mole or less.

(5) A method for manufacturing a perpendicular magnetic recording medium according to any one of (1) to (4), wherein the diffusive layer contains at least one of Hf, Zr, Ti, Al, Ta, Nb, Sc, V, and Y.

(6) A method for manufacturing a perpendicular magnetic recording medium according to any one of (1) to (5), wherein the magnetic layer is made of at least one alloy of CoCrPt, CoCrPtB, CoCrNiPt, CoCr, CoCrTa, and CoCrPtTa.

(7) A method for manufacturing a perpendicular magnetic recording medium according to any one of (1) to (6), wherein a maximum annealing temperature is 500° C. or less.

(8) A method for manufacturing a perpendicular magnetic recording medium according to any one of (1) to (7), wherein the annealing is carried out under vacuum conditions of 1×10⁻³ Pa or less.

(9) A method for manufacturing a perpendicular magnetic recording medium according to any one of (1) to (8), wherein the annealing is a rapid annealing having a temperature rising rate of 30° C./second or greater.

(10) A perpendicular magnetic recording medium produced by a method for manufacturing a perpendicular magnetic recording medium according to any one of (1) to (9).

(11) A perpendicular magnetic recording medium comprising a magnetic recording layer on a non-magnetic substrate, wherein the magnetic recording layer comprises magnetic crystal grains and non-magnetic matrix to the magnetic crystal grains, the magnetic crystal grains contain Co and Cr, and the non-magnetic matrix contains at least one of Hf, Zr, Ti, Al, Ta, and Nb.

(12) A perpendicular magnetic recording medium according to (11), wherein the non-magnetic matrix is an amorphous material produced by a reaction with Co.

(13) A perpendicular magnetic recording medium according to (11) or (12), wherein an average diameter of the magnetic crystal grains is 10 nm or less.

(14) A perpendicular magnetic recording medium according to any one of (11) to (13), wherein the distance of the matrix between the magnetic grains of the amorphous material is in a range of 1 nm to 5 nm.

(15) A perpendicular magnetic recording medium according to any one of (11) to (14), wherein the matrix in the vicinity of the magnetic crystal grains has a Co-enriched composition.

(16) A perpendicular magnetic recording medium according to any one of (11) to (15), wherein a perpendicular coercive force is 553,000 A/m (7,000 Oe) or greater in a case where a thickness of the magnetic recording layer is 20 nm.

(17) A magnetic recording/reproducing apparatus comprising the perpendicular magnetic recording medium according to any one of (10) to (16).

According to the present invention, it is possible to easily produce a perpendicular magnetic recording medium having a high coercive force by annealing at low temperatures and/or in a short time.

Below, the present invention will be explained in detail.

The perpendicular magnetic recording medium of the present invention comprises a magnetic recording layer which is produced by thermally treating a laminating film comprising a Co-based magnetic layer and a diffusive layer on a substrate. The cross-sectional structure of the perpendicular magnetic recording medium is shown in FIG. 1. The perpendicular magnetic recording medium 1 of the present invention comprises a seed layer 3, an underlayer 4, and a Co-based magnetic layer 5 deposited on a non-magnetic substrate 2 in this order. In addition, after formation of a diffusive layer 6 on the magnetic layer 5, the surface of the diffusive layer 6 is covered with a protective layer 7. Moreover, in FIG. 1, the magnetic layer 5 and the diffusive layer 6 are presented separately; however, after annealing, these layers are changed to a magnetic recording layer.

The substrate 2 of the perpendicular magnetic recording medium 1 is made of a non-magnetic matrix material, and has a disc shape. Examples of the non-magnetic matrix material include Al alloys such as Al—Mg alloys containing Al as a main component, soda glass, aluminosilicate-based glass, crystallized glass, silicon, titanium, ceramics, carbon, or the like. The manufacturing method of the present invention comprises a annealing. Metal substrates such as an Al alloy substrate and a resin substrate have relatively low melting points. Therefore, there is a limitation of usage of these substrates. A substrate made of a material having a high melting point, such as glass or silicon, is preferable.

An average surface roughness of the non-magnetic substrate 2 is preferably 0.8 nm or less, and more preferably 0.5 μm or less, because such a non-magnetic substrate is suitable for a high density magnetic recording in which the flying height of a magnetic head is small. Surface waviness (Wa) also should be low, preferably 0.3 nm or less, and more preferably 0.25 nm or less, because of the same reason as above.

The magnetic layer may be made of any magnetic material of Co-based alloys. Specifically, examples of the magnetic material of Co based alloys include CoCrPt, CoCrTa, CoNiCr, and these alloys with elements such as Ni, Cr, Pt, Ta, W, and B added, such as CoCrPtTa, CoCrPtB, CoNiPt, and CoNiCrPtB, and these alloys with a compound such as SiO₂ added.

In the present invention, the magnetic layer made of a CoCrPt-based material containing Pt and Co is preferably used because a high coercive force can be easily obtained with this material. The thickness of the magnetic layer should be adjusted by considering a resultant thickness of the recording layer after the annealing process, and this is generally in a range of 5 nm to 30 nm. In addition, a magnetic layer containing oxides, for example, SiO₂, Cr₂O₃, and the like, is proposed as a high density perpendicular magnetic recording medium, and these magnetic layers can also be used in the present invention. However, it is not necessary for the present invention to use such oxides. That is, the present invention does not always require a magnetic layer containing non-magnetic oxides.

As the diffusive layer, a pure metal film or an alloy film is used. In particular, a film made of a material containing metal elements, which have a small atomic radius, a low melting point, and a large absolute value of an enthalpy of formation of Co alloy (ΔHCo˜X). Examples of such materials are hafnium (Hf), zirconium (Zr), titanium (Ti), aluminum (Al), tantalum (Ta), niobium (Nb), scandium (Sc), vanadium (V), yttrium (Y).

Preferable characteristics of the metal elements are a melting point at 1 atm be 2,500° C. or less, an atomic radius be 1.60 angstroms or less, and ΔHCo˜X is −40 kJ/mole or less. The elements described above satisfy these conditions.

In a perpendicular magnetic recording medium of the present invention, the diffusive layer is preferably laminated on, under, and both on and under the magnetic layer, and it is preferable that the diffusive layer and the magnetic layer be preferably in direct contact.

In order to form the magnetic layer and the diffusive layer, conventional sputtering methods such as a DC sputtering method, RF sputtering method, and the like are used. When the laminate film comprising the magnetic layer and the diffusive layer is formed, the substrate may be heated to a specific temperature. In order to control crystal structure of crystals contained in the magnetic layer, the underlayer 4 and the seed layer 3 are often formed under the magnetic layer 5. These layers are made of metal or metallic alloy, and they are used to align the c-axis direction of an hcp crystal structure of a Co-based alloy comprising the magnetic layer to a perpendicular direction relative to the substrate. As the underlayer 4, a metal film having an hcp structure, such as a Ru film, is often used. As the seed layer 3, any film can be used as long as a c-axis of Ru is arranged in a perpendicular direction relative to the substrate surface, and examples of this include a Ti film.

A soft underlayer (SUL), which is a layer made of a soft magnetic material, can be laminated under the underlayer 4 or the seed layer 3, in addition to the structure shown in FIG. 1. The SUL is provided to enhance the efficiency of the recording magnetic field of a perpendicular magnetic recording head, and a soft magnetic material such as CoZrNb, and FeCo is widely used for the SUL.

If the temperature of the annealing is high, the annealing time is short. In contrast, if the temperature thereof is low, the treatment time is long. The conditions for the annealing can be selected depending on materials used for the substrate and the other layers and desired process time and the like. In general, as long as the performance and shape of the media are not impaired, the annealing time is prefer to be short. Examples of a heater used in the annealing include a lamp heater, a carbon composite heater, a sheath heater, or the like. In addition, a furnace anneal using an electric furnace can also be used. In order to prevent the surface of the laminate film from oxidation, it is preferable for the annealing to be carried out under high vacuum conditions.

In order to prevent the surface of the media from oxidation during the entire process, a series of annealing is preferably carried out under a pressure of 1×10⁻³ Pa or less, and more preferably under a pressure of 5×10⁻⁴ Pa or less. For the same reasons, the highest temperature is preferably 500° C. or less. The lower limit for the annealing is 200° C. Any temperature rising rate can be chosen, but higher ratio is preferable from the viewpoint of he productivity. Specifically, the temperature rising rate of 3° C./second or greater is preferable.

Temperature of the heater is not constant during the annealing. Reputation of the process rises the temperature of the heater from room temperature to a saturation value. When several media are continuously subjected to the annealing, even if the heater turns off, the temperature does not fall to room temperature but a relatively higher temperature due to the influence of a previous annealing. Therefore, in the case of mass production, the annealing temperature and the annealing time should be modified by considering the influence described above.

In the perpendicular magnetic recording medium of the present invention, the magnetic recording layer comprises magnetic crystal grains and a non-magnetic matrix to the magnetic crystal grains. The magnetic crystal grains contain Co and Cr, the non-magnetic matrix contains at least one of Hf, Zr, Ti, Al, Ta, Nb, Sc, V, and Y, and the perpendicular magnetic recording medium has perpendicular magnetic anisotropy. In particular, the non-magnetic matrix material is preferably an amorphous material produced by a reaction between Co and precipitated elements in the medium. Furthermore, the magnetic crystal grains preferably have an average diameter in a range of 5 nm to 10 nm. The distance between magnetic crystal grains is prefer to be from 1 nm to 5 nm. In addition, the non-magnetic matrix material in the vicinity of the magnetic crystal grains preferably has a Co-enriched composition.

So-called discrete track magnetic recording media, in which recording tracks are separated physically to suppress the magnetic interference between tracks and to improve the recording density, have been suggested. The manufacturing method of the present invention can be used as a manufacturing method for this discrete track media.

FIG. 6 shows one embodiment of a magnetic recording/reproducing apparatus of the present invention. The magnetic recording/reproducing apparatus comprises a magnetic recording media 10 having the above-mentioned structure, a medium driving portion 11 for rotating the magnetic recording medium 10, a magnetic head 12 for recording information to the magnetic recording medium 10 and reproducing information from the magnetic recording medium 10, a head driving portion 13, and a recording and reproducing signal processing portion 14. The recording and reproducing signal processing portion 14 processes input data and sends recorded signals to the magnetic head 12, or processes reproduced data from the magnetic head 12 and outputs data.

### BRIEF DESCRIPTION OF DRAWINGS

FIG. 1 is a cross-sectional drawing showing one perpendicular magnetic recording medium of the present invention.

FIG. 2 shows relationships between the annealing time and the perpendicular coercive force in Examples 1 to 11.

FIG. 3 shows a relationship between the annealing time and the perpendicular coercive force in Examples 12 to 18.

FIG. 4 shows relationships between the annealing time and the perpendicular coercive force in Examples 19 to 32.

FIG. 5 shows relationships between the annealing time and the perpendicular coercive force in Examples 33 to 48.

FIG. 6 shows one embodiment of a magnetic recording/reproducing apparatus of the present invention.

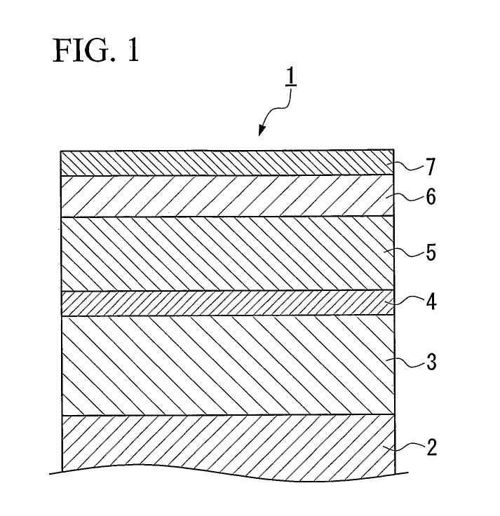

### BEST MODE FOR CARRYING OUT THE INVENTION

Below, the present invention will be explained with reference to the following Examples and Comparative Examples.

### EXAMPLES 1 TO 48 AND COMPARATIVE EXAMPLES 1 TO 7

A crystallized glass substrate was put in a vacuum vessel, and air inside the vessel was evacuated to 1×10⁻⁴ Pa. The following layers were laminated in the following order.
(1) Seed layer: Ti (25 nm)
(2) Underlayer: Ru (5 nm)
(3) Magnetic layer: 68Co-16Pt-16Cr alloy (20 nm or 10 nm)
   (the ratio of each element is denoted by “at %”)
(4) Diffusive layer: one of Hf, Ti, Al (5 nm)
(5) Protective layer: C

After the seed layer, which was made of Ti and had a thickness of 25 nm, was laminated on the substrate by a DC-sputtering method, the substrate was heated to 350° C. Then, the underlayer, which was made of Ru and had a thickness of 5 nm, the magnetic layer, which was made of 68Co-16Pt-16Cr alloy and had a thickness of 20 nm or 10 nm, and the diffusive layer, which was made of one of Hf, Ti, and Al, and had a thickness of 5 nm, were formed. After that, these layers were annealed using a constant power type lamp heater (2 kW) for a given time. The time for the annealing varied as shown in Tables 1 and 2. Just after completion of the annealing, the protective layer made of carbon was formed to produce a sample. These processes were carried out under vacuum conditions.

Coercive force in a perpendicular direction relative to the surface of the substrate of the samples produced in this manner was measured using a Vibrating Sample Magenetometer (VSM).

The following Tables 1 and 2 show the material used for the diffusive layer, the thickness of the magnetic layer, the time for annealing, and the perpendicular coercive force of the sample. 1 Oe is about 79 A/m.

TABLE 1

| | | Thickness of | Time | |
|---|---|---|---|---|
| | | the magnetic | for the | Perpendicular |
| | Material of the | layer | annealing | coercive force |
| | diffusive layer | (nm) | (second) | (Oe) |
| Com. Ex. 1 | Hf | 20 | 0 | 5603 |
| Ex. 1 | Hf | 20 | 2 | 5552 |
| Ex. 2 | Hf | 20 | 4 | 5651 |
| Ex. 3 | Hf | 20 | 6 | 5662 |
| Ex. 4 | Hf | 20 | 10 | 8119 |
| Ex. 5 | Hf | 20 | 12 | 8652 |
| Com. Ex. 2 | Hf | 10 | 0 | 3690 |
| Ex. 6 | Hf | 10 | 2 | 4121 |
| Ex. 7 | Hf | 10 | 4 | 3701 |
| Ex. 8 | Hf | 10 | 6 | 4822 |
| Ex. 9 | Hf | 10 | 8 | 6099 |
| Ex. 10 | Hf | 10 | 10 | 7001 |
| Ex. 11 | Hf | 10 | 12 | 6748 |
| Com. Ex. 3 | Zr | 10 | 0 | 3918 |
| Ex. 12 | Zr | 10 | 2 | 4041 |
| Ex. 13 | Zr | 10 | 4 | 4307 |
| Ex. 14 | Zr | 10 | 6 | 4898 |
| Ex. 15 | Zr | 10 | 8 | 5927 |
| Ex. 16 | Zr | 10 | 10 | 6367 |
| Ex. 17 | Zr | 10 | 12 | 6571 |
| Ex. 18 | Zr | 10 | 13 | 6000 |

TABLE 2

| | | Thickness of | Time | |
|---|---|---|---|---|
| | | the magnetic | for the | Perpendicular |
| | Material of the | layer | annealing | coercive force |
| | diffusive layer | (nm) | (second) | (Oe) |
| Com. Ex. 4 | Ti | 20 | 0 | 4851 |
| Ex. 19 | Ti | 20 | 2 | 4628 |
| Ex. 20 | Ti | 20 | 4 | 5022 |
| Ex. 21 | Ti | 20 | 6 | 4841 |
| Ex. 22 | Ti | 20 | 8 | 5311 |
| Ex. 23 | Ti | 20 | 10 | 6089 |
| Ex. 24 | Ti | 20 | 12 | 7800 |
| Ex. 25 | Ti | 20 | 14 | 7620 |
| Com. Ex. 5 | Ti | 10 | 0 | 4208 |
| Ex. 26 | Ti | 10 | 2 | 4022 |
| Ex. 27 | Ti | 10 | 4 | 4307 |
| Ex. 28 | Ti | 10 | 6 | 4795 |
| Ex. 29 | Ti | 10 | 8 | 4470 |
| Ex. 30 | Ti | 10 | 10 | 5572 |
| Ex. 31 | Ti | 10 | 12 | 6983 |
| Ex. 32 | Ti | 10 | 14 | 6211 |
| Com. Ex. 6 | Al | 20 | 0 | 5211 |
| Ex. 33 | Al | 20 | 2 | 5312 |
| Ex. 34 | Al | 20 | 4 | 5004 |
| Ex. 35 | Al | 20 | 6 | 4992 |
| Ex. 36 | Al | 20 | 8 | 5354 |
| Ex. 37 | Al | 20 | 10 | 5743 |
| Ex. 38 | Al | 20 | 12 | 6852 |
| Ex. 39 | Al | 20 | 13 | 7195 |
| Ex. 40 | Al | 20 | 14 | 7204 |
| Com. Ex. 7 | Al | 10 | 0 | 4530 |
| Ex. 41 | Al | 10 | 2 | 4670 |
| Ex. 42 | Al | 10 | 4 | 4589 |
| Ex. 43 | Al | 10 | 6 | 4547 |
| Ex. 44 | Al | 10 | 8 | 4492 |
| Ex. 45 | Al | 10 | 10 | 4912 |
| Ex. 46 | Al | 10 | 12 | 5652 |
| Ex. 47 | Al | 10 | 13 | 5452 |
| Ex. 48 | Al | 10 | 14 | 5461 |

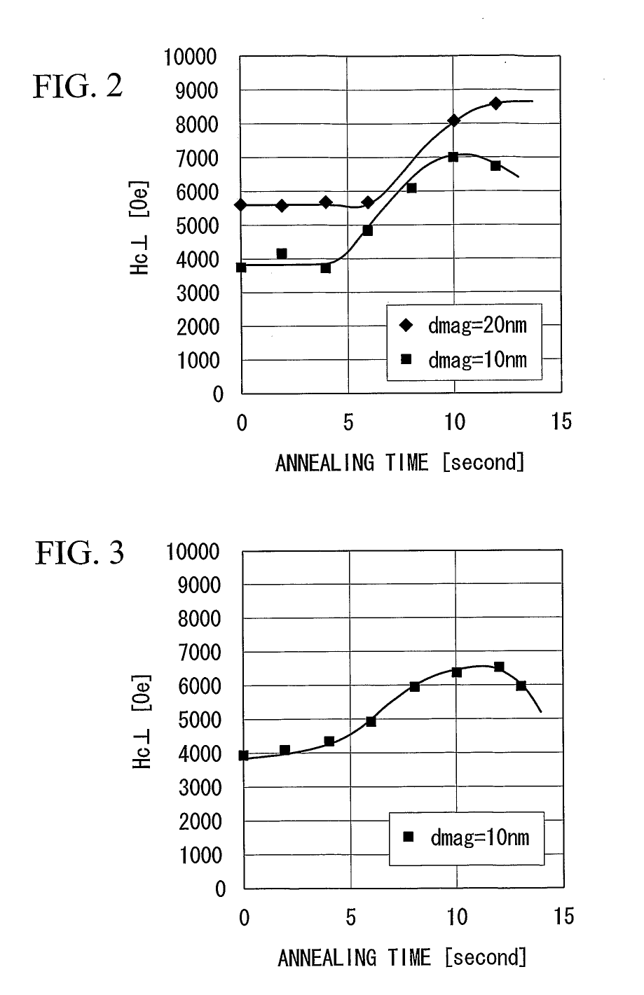

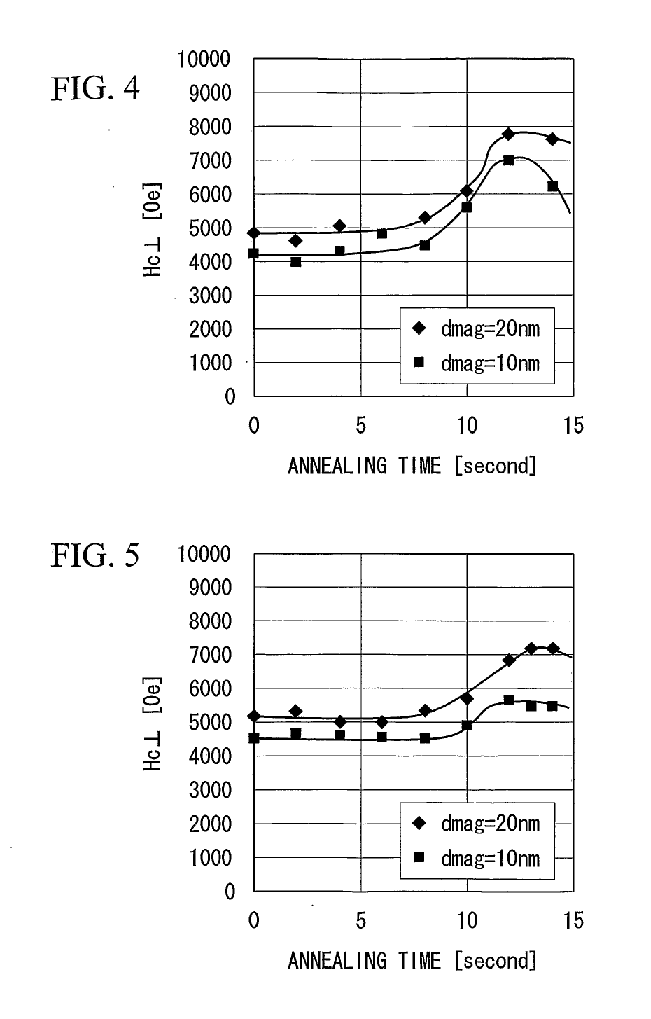

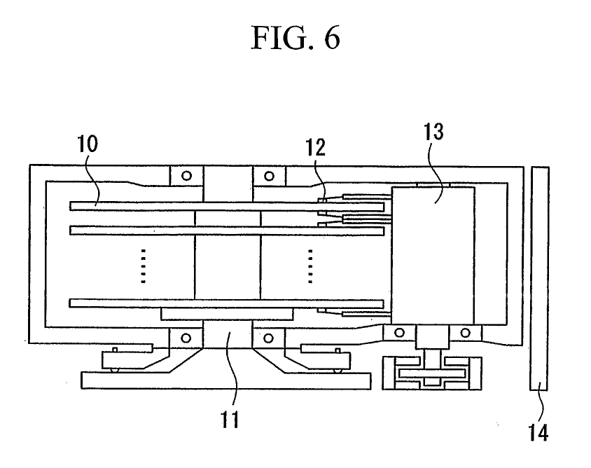

The relationships between the perpendicular coercive force and the annealing time in Examples 1 to 11 are shown in FIG. 2. The relationship between those in Examples 12 to 18 is shown in FIG. 3. The relationships between those in Examples 19 to 32 are shown in FIG. 4. The relationships between those in Examples 33 to 48 are shown in FIG. 5.

As shown in Table 2, and FIGS. 4 and 5, the perpendicular coercive force in the perpendicular magnetic recording medium comprising the diffusive layer made of titanium or aluminum in Examples 19 to 48 started to increase rapidly when the time for the annealing was about 10 seconds. In the perpendicular magnetic recording medium comprising the diffusive layer made of titanium, when the thickness of the magnetic layer was 20 nm, the largest perpendicular coercive force was 7,800 Oe, and when it was 10 nm, the largest perpendicular coercive force was about 7,000 Oe. In the perpendicular magnetic recording medium comprising the diffusive layer made of aluminum, when the thickness of the magnetic layer was 20 nm, the largest perpendicular coercive force was about 7,200 Oe, and when it was 10 nm, the largest perpendicular coercive force was 5,650 Oe.

In contrast, as shown in Table 1, and FIGS. 2 and 3, the perpendicular coercive force in the perpendicular magnetic recording medium comprising the diffusive layer made of hafnium or zirconium in Examples 1 to 18 started to rapidly increase when the time for the annealing was only 6 seconds. In the perpendicular magnetic recording medium comprising the diffusive layer having a thickness of 20 nm, and made of hafnium, when the annealing time was 12 seconds, the perpendicular coercive force reached about 8,650 Oe. In the perpendicular magnetic recording medium comprising the diffusive layer having a thickness of 10 nm, and made of hafnium, when the annealing time was 10 seconds, the perpendicular coercive force reached about 7,000 Oe.

### COMPARATIVE EXAMPLES 8 TO 13

Comparative perpendicular magnetic recording media were prepared in a manner identical to that of Example 1 of the present invention, except that the magnetic recording layer was formed by sputtering using an alloy target while the substrate was heated. This method was conventional. That is, the magnetic recording layers of the perpendicular magnetic recording media in Examples were prepared by forming the magnetic layer and the diffusive layer separately and thermally treating them. In contrast, in Comparative Examples 8 to 13, the magnetic recording layers were formed by sputtering using alloy targets having the compositions shown in Table 3. Then, the perpendicular coercive force of the comparative samples was measured. The material of the magnetic layer in Comparative Example 8 was the material (68Co-16Pt-16Cr) used in the magnetic layer in Examples. Materials of the magnetic layers in Comparative Examples 9 to 13 were materials in which Hf or Zr (the material of the diffusive layer in Examples) was added to 68Co-16Pt-16Cr alloy (the material of the magnetic layer in Examples). Specifically, 68Co-16Pt-14Cr-2Hf, 68Co-16Pt-14Cr-4Hf, 68Co-16Pt-14Cr-2Zr, and 68Co-16Pt-12Cr-4Zr were used as the material of the magnetic layer in Comparative Examples 9 to 13. The temperature of the substrate was adjusted to 350° C. at which the perpendicular coercive force started to rise rapidly in Examples. The measurement results are shown in the following Table 3.

TABLE 3

| | | Thickness of | Perpendicular |
|---|---|---|---|
| | Material of the magnetic | the magnetic | coercive force |
| | recording layer | layer (nm) | (Oe) |
| Com. Ex 8 | 68Co—16Pt—16Cr | 20 | 3865 |
| Com. Ex 9 | 68Co—16Pt—14Cr—2Hf | 20 | 4021 |
| Com. Ex 10 | 68Co—16Pt—14Cr—4Hf | 20 | 3902 |
| Com. Ex 12 | 68Co—16Pt—14Cr—2Zr | 10 | 4104 |
| Com. Ex 13 | 68Co—16Pt—14Cr—4Zr | 10 | 4129 |

As shown in Table 3, the perpendicular magnetic recording medium in Comparative Examples 8 to 13, in which the magnetic recording layer was formed by sputtering while heating the substrate, had a remarkably lower coercive force, compared with the coercive force of the perpendicular magnetic recording media in Examples in which the magnetic recording layer was formed by forming the magnetic layer and the diffusive layer separately and thermally treating them.

As shown above, the present invention gives great advantages to the current art of the manufacturing process of the perpendicular magnetic recording medium. That is, higher perpendicular coercive force can be obtained with relatively lower annealing temperature and/or relatively shorter heat treatment time by using the diffusive layer, which includes Hf, Zr, Ti, Al.

That is, in the perpendicular magnetic recording media, which were produced by the method for a perpendicular magnetic recording medium of the present invention, in which the diffusive layers were made of hafnium, zirconium, titanium, or aluminum, and the laminate film comprising the magnetic layer and the magnetic layer was thermally treated, it was easy to obtain a higher coercive force at lower temperatures in a shorter time. These effects are preferable for perpendicular magnetic recording media.

### INDUSTRIAL APPLICABILITY

According to the manufacturing method for a perpendicular magnetic recording medium of the present invention, in which the diffusive layer and the magnetic layer are formed to produce the laminate film, and the laminate film is thermally treated, a perpendicular magnetic recording medium having a higher coercive force can be obtained at lower temperatures and in a shorter time than the conventional conditions.

1. A method for manufacturing a perpendicular magnetic recording medium comprising a magnetic recording layer on a non-magnetic substrate, in which at least a magnetic layer containing Co and a diffusive layer are stacked each other, and the stacked layers are annealed to produce a magnetic recording layer.

2. A method for manufacturing a perpendicular magnetic recording medium according to claim 1, wherein the diffusive layer is a pure metal film or an alloy film.

3. A method for manufacturing a perpendicular magnetic recording medium according to claim 1, wherein the diffusive layer is laminated on and/or under the magnetic layer.

4. A method for manufacturing a perpendicular magnetic recording medium according to claim 1, wherein the diffusive layer contains elements having an atomic radius of 1.60 angstroms or less, a melting point of 2,500° C. or less, and an enthalpy of formation of alloy with Co being −40 kJ/mole or less.

5. A method for manufacturing a perpendicular magnetic recording medium according to claim 1, wherein the diffusive layer contains at least one of Hf, Zr, Ti, Al, Ta, Nb, Sc, V, and Y.

6. A method for manufacturing a perpendicular magnetic recording medium according to claim 1, wherein the magnetic layer is made of at least one alloy of CoCrPt, CoCrPtB, CoCrNiPt, CoCr, CoCrTa, and CoCrPtTa.

7. A method for manufacturing a perpendicular magnetic recording medium according to claim 1, wherein a maximum annealing temperature is 500° C. or less.

8. A method for manufacturing a perpendicular magnetic recording medium according to claim 1, wherein the annealing is carried out under vacuum conditions of 1×10⁻³ Pa or less.

9. A method for manufacturing a perpendicular magnetic recording medium according to claim 1, wherein the annealing is a rapid annealing having a temperature rising rate of 30° C./second or greater.

10. A perpendicular magnetic recording medium produced by a method for manufacturing a perpendicular magnetic recording medium according to claim 1.

11. A perpendicular magnetic recording medium comprising a magnetic recording layer on a non-magnetic substrate, wherein the magnetic recording layer comprises magnetic crystal grains and a non-magnetic matrix to the magnetic crystal grains, the magnetic crystal grains contain Co and Cr, and the non-magnetic matrix contains at least one of Hf, Zr, Ti, Al, Ta, and Nb.

12. A perpendicular magnetic recording medium according to claim 11, wherein the non-magnetic matrix is an amorphous material produced by a reaction with Co.

13. A perpendicular magnetic recording medium according to claim 11, wherein an average diameter of the magnetic crystal grains is 10 nm or less.

14. A perpendicular magnetic recording medium according to claim 11, wherein a distance of the matrix between the magnetic grains of the amorphous material is in a range of 1 nm to 5 nm.

15. A perpendicular magnetic recording medium according to claim 11, wherein the matrix in the vicinity of the magnetic crystal grains has a Co-enriched composition.

16. A perpendicular magnetic recording medium according to claim 11, wherein perpendicular coercive force is 553,000 A/m (7,000 Oe) or greater in a case that a thickness of the magnetic recording layer is 20 nm n.

17. A magnetic recording/reproducing apparatus comprising the perpendicular magnetic recording medium according to claim 10.
